(19) United States
(12) Patent Application Publication
(10) Pub. No.: US 2008/0259493 A1
(43) Pub. Date: Oct. 23, 2008

(54) Wire-assisted write device with high thermal reliability

(75) Inventors: Mark T. Kief, Lakeville, MN (US); Johannes Van Ek, Minnetonka, MN (US); Eric S. Linville, Shakopee, MN (US); William P. Vavra, Maple Plain, MN (US); Vladyslav A. Vas'ko, Apple Valley, MN (US)

Correspondence Address: KINNEY & LANGE, P.A., 312 SOUTH 3RD STREET, THE KINNEY & LANGE BUILDING, MINNEAPOLIS, MN, 55415, US

(73) Assignee: Seagate Technology LLC, Scotts Valley, CA (US)

(21) Appl. No.: 11/702,266

(22) Filed: Feb. 5, 2007

(51) Int. Cl. G11B 5/23; G11B 5/127

(52) U.S. Cl. 360/119.01

(57) ABSTRACT

A magnetic device includes a first pole having a first pole tip. A conductor, which is adjacent to an edge of the first pole tip, carries current to generate a second field that augments a first field generated by the first pole. The width of the conductor is in the range of about one to about five times the width of the trailing edge of the first pole tip.

### BACKGROUND OF THE INVENTION

The present invention relates to magnetic devices. More particularly, the present invention relates to a magnetic device that employs a current-carrying conductor to provide a magnetic field that augments a write field.

Two general techniques for magnetically recording information on a storage medium include longitudinal recording and perpendicular recording. In longitudinal recording, the direction of the magnetic field in a plane of the storage medium is altered in a manner to store information. In perpendicular recording, the magnetic field is impressed into the storage medium in a direction that is perpendicular to the plane of the medium. With the magnetic field direction perpendicular to the plane of the medium as opposed to parallel with the plane, information can be stored at higher density.

There has been an ongoing effort to increase the bit densities in magnetic recording. Bit density refers to the number of flux reversals (i.e., changes in the direction of a magnetic field) that can be written to the storage medium in a given area. The size of such a flux transition is related to the size and focus of a magnetic write field generated by a magnetic head. One traditional type of magnetic head is known as an inductive head, which uses a current passed through a coil of wire. This causes a magnetic field to be generated across a gap formed between two pole tips.

There is also an ongoing effort to use magnetic storage media that have a high coercivity. Such medium require stronger and more focused write field to impress a flux reversal. One approach to providing a stronger write field is to incorporate a conductive material adjacent to the tip of the write pole. When a current is caused to flow through the conductive material, a magnetic field is produced that combines with the write field to provide a stronger field at the medium. However, the small geometry of the conductor, combined with the high current through the conductor, results in substantial heat generation due to Joule heating. Unless this heat is minimized and dissipated efficiently, the temperature rise will be excessive, and the desired high currents will result in poor thermal reliability and rapid failure of the device.

### BRIEF SUMMARY OF THE INVENTION

The present invention relates to a magnetic device including a first pole having a first pole tip. A conductor, which is adjacent to an edge of the first pole tip, carries current to generate a second field that augments a first field generated by the first pole. The width of the conductor is in the range of about one to about five times the width of the trailing edge of the first pole tip.

### BRIEF DESCRIPTION OF THE DRAWINGS

FIG. 1 is a side view of a magnetic writer including a write pole and a thermally reliable conductor for providing a write assist field disposed relative to a magnetic medium.

FIG. 2 is a medium confronting surface view of a write pole tip and a thermally reliable conductor for providing a write assist field.

FIG. 3 is a graph showing the write assist field generated by conductors of different lengths at a fixed current.

FIG. 4 is a graph showing the write assist field generated by conductors of different lengths at a fixed power.

FIG. 5 is a graph showing the maximum write assist field and the minimum gradient generated by conductors of different lengths at a fixed temperature.

### DETAILED DESCRIPTION

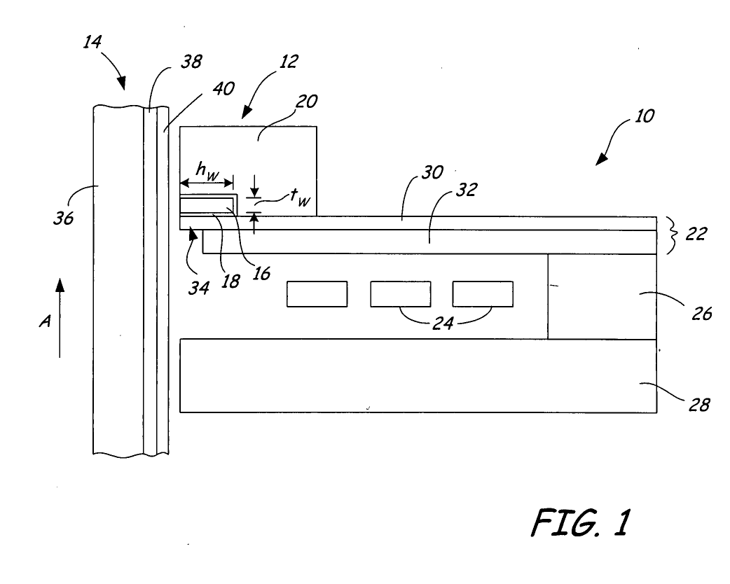

FIG. 1 is a side view of magnetic writer 10 and thermally reliable write assist element 12 disposed proximate to magnetic medium 14. Write assist element 12 includes conductor 16 having height h_{w} and thickness t_{w}, insulating material 18, and heat sink 20. Magnetic writer 10 includes write pole 22, conductive coils 24, back via 26, and return pole 28. Write pole 22, which includes main portion 30 and yoke portion 32, is connected to return pole 28 by back via 26 distal from the front surface of magnetic writer 10 that confronts magnetic medium 14. Conductive coils 24 surround back via 26 such that turns of conductive coils 24 are disposed in the gap between write pole 22 and return pole 28.

Magnetic writer 10 is carried over the surface of magnetic medium 14, which is moved relative to magnetic writer 10 as indicated by arrow A such that write pole 22 is the trailing pole and is used to physically write data to magnetic medium 14. Conductive coils 24 surround back via 26 such that, when a write current is caused to flow through conductive coils 24, the magnetomotive force in the coils magnetizes write pole 22 and return pole 28. This causes a write field to be generated at pole tip 34 of main portion 30, which is used to write data to magnetic medium 14. The direction of the write field at pole tip 34, which is related to the state of the data written to magnetic medium 14, is controllable based on the direction that the write current that flows through conductive coils 24.

Magnetic writer 10 is shown merely for purposes of illustrating a construction that may be used in conjunction with write assist element 12 of the present invention, and variations on this design may be made. For example, while write pole 22 includes main portion 30 and yoke portion 32, write pole 22 can also be comprised of a single layer of magnetic material, return pole 28 may be removed from the structure to provide a single pole writer configuration, or an additional return pole may be magnetically coupled to write pole 22 on a side opposite return pole 28. In the latter case, a shield may additionally be formed to extend from the trailing return pole toward write pole 22 proximate the medium confronting surface in a “trailing shield” magnetic writer design. In addition, magnetic writer 10 is configured for writing data perpendicularly to magnetic medium 14, but magnetic writer 10 and magnetic medium 14 may also be configured to write data longitudinally. Furthermore, a magnetic reader may be provided adjacent to and carried over magnetic medium 14 on the same device as magnetic writer 10.

Magnetic medium 14 includes substrate 36, soft underlayer (SUL) 38, and medium layer 40. SUL 38 is disposed between substrate 36 and medium layer 40. Magnetic medium 14 is positioned proximate to magnetic writer 10 such that the surface of medium layer 40 opposite SUL 38 faces write pole 22. In some embodiments, substrate 36 is comprised of a non-magnetic material, such as aluminum and aluminum based alloys, SUL 38 is comprised of a magnetically soft (i.e., high permeability) material, and medium layer 40 is comprised of a granular material having a high perpendicular anisotropy and high coercivity.

SUL 38 is located below medium layer 40 of magnetic medium 14 and enhances the amplitude of the write field produced by the write pole 22. The image of the write field is produced in SUL 38 to enhance the field strength produced in magnetic medium 14. As the write field from write pole 22 (and in particular, pole tip 34) passes through medium layer 40, medium layer 40 is magnetized perpendicular to the medium plane to store data based on the write field direction. The flux density that diverges from pole tip 34 into SUL 38 returns through return pole 28. Return pole 28 is located a sufficient distance from write pole 22 such that the material of return pole 28 does not affect the magnetic flux of write pole 22.

In order to write data to high coercivity medium layer 40, a stronger write field may be provided to impress magnetization reversal in the medium. To accomplish this, write assist element 12 is provided proximate to write pole 22 and magnetic medium 14. As will be described in more detail herein, write assist element 12 is operable to generate a magnetic field that augments the write field produced by write pole 22. The combination of the write field and the magnetic field generated by write assist element 12 overcomes the high coercivity of medium layer 40 to permit controlled writing of data to magnetic medium 14. In addition, write assist element 12 is thermally stable in that all external interfaces of conductor 16 allow for dissipation of heat that is produced by write assist element 12.

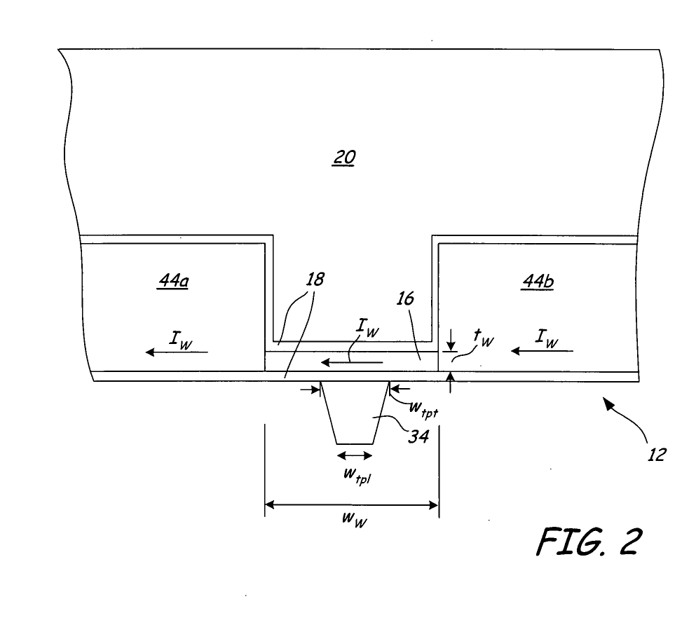

FIG. 2 is a medium confronting surface view of pole tip 34 positioned relative to write assist element 12. Conductor 16 of write assist element 12 has a width w_{w} and is positioned along the medium confronting surface adjacent to the trailing edge of pole tip 34. In an alternative embodiment, write assist element 12 is disposed adjacent a leading edge of pole tip 34. First electrical contact 44a is electrically connected to one end of conductor 16 and second electrical contact 44b is electrically connected to an opposite end of conductor 16. In an alternative embodiment, electrical contacts 44a and 44b overlay portions of conductor 16 that extend beyond the edges of pole tip 34, and the overlaid surfaces of electrical contacts 44a and 44b are very much larger than cross-section of conductor 16. Electrical contacts 44a and 44b are coupled to a current source (not shown), which provides a wire current I_{w} that flows through electrical contacts 44a and 44b and conductor 16. Current I_{w} generates a magnetic field around conductor 16 (hereinafter referred to as a write assist field). While conductor 16 is shown as having a width w_{w}, a height h_{w}, and a thickness t_{w}, conductor 16 may have any shape that is effective for generating an augmenting write assist field when current I_{w} is passed through it.

The direction of current I_{w} determines the direction of the write assist field that is generated around conductor 16 pursuant to the right-hand rule. In order to provide a magnetic field that augments the write field produced by pole tip 34, current I_{w} is directed to generate a write assist field that has the same orientation as the write field. At high current densities through conductor 16 (e.g., greater than 10⁹ A/cm²), there is a large enough flux density generated in pole tip 34 such that the magnetization of pole tip 34 is driven to near saturation, beyond which the additional field from conductor 34 augments the field from write pole 22. This results in magnetic field amplification at magnetic medium 14. In addition, the field profile from conductor 16 maps onto that of pole tip 34 so as to yield improved field gradients. Furthermore, fields at the trailing edge of conductor 16 cancel stray fields from pole tip 34, leading to a sharper down-track field profile. Write pole 22 is separated from conductor 16 and electrical contacts 44a and 44b by a thin layer of insulating material 18 to provide electrical isolation of these components while maintaining them in close proximity to each other.

When current I_{w} passes through conductor 16, it is heated due to Joule heating. In order to provide a reliable device, this heat should be dissipated efficiently to allow maximum current flow without excessive heating. In magnetic writer 10, various heat dissipating mechanisms are provided to efficiently reduce the heat to allow maximum current flow without excessive heating. For example, conductor 16 may be made of a material having good electrical and thermal conductivites (e.g., Au, Ag, or Cu) and conductor 16 may made as short as possible, since any extra width unnecessarily increases the resistance of conductor 16. In various embodiments, conductor 16 has a width w_{w} of less than about 1.0 μm. Also, electrical contacts 44a and 44b may be made of a material having good electrical and thermal conductivities (e.g., Au, Ag, or Cu) to allow for efficient removal of heat generated by conductor 16, and the dimensions of electrical contacts 44a and 44b may be made very large compared to conductor 16 to provide a thermal conduction path for heat generated by the wire. In addition, heat sink 20, which is separated from conductor 16 and electrical contacts 44a and 44b by insulating material 18, may be provided to surround the surfaces/interfaces of conductor 16 and electrical contacts 44a and 44b away from the medium confronting surface to allow for heat transfer across insulating material 18. Example materials that may be used for heat sink 20 include materials that have high thermal conductivity, such as Mo, W, Al, Cu, Au, Rh, Cr, Ir, Nb, Pd, Pt, Ru, Ag, other transition metals, and alloys thereof. The material used for heat sink 20 may also have low electrical conductivity to prevent undesired conduction of current I_{w} to heat sink 20. Furthermore, conductor 16 is disposed proximate to pole tip 34 to allow for good heat transfer across insulating material 18 to write pole 22, and the medium confronting surface provides good heat transfer to magnetic medium 14 due to the large thermal conductivity of this interface. In the alternative trailing shield magnetic writer design described above, the shield extending from the trailing return pole may also dissipate heat from conductor 16. In this way, heat dissipation is provided from all interfaces of conductor 16 to minimize temperature rise in conductor 16 and provide good thermal reliability for magnetic device 10.

Pole tip 34, which has a leading edge width wₜₚₗ and a trailing edge width wₜₚₜ, has a trapezoidal shape at magnetic medium 14 to decrease the dependence of the track width recorded by write pole 22 on the skew angle of magnetic writer 10 as it is carried over magnetic medium 14. This improves the recording density of magnetic writer 10 and reduces the bit error rate and side writing and erasure on adjacent tracks of magnetic medium 14. It should be noted that while pole tip 34 is shown having a trapezoidal shape, pole tip 34 may have any shape at magnetic medium 14 that is capable of generating a write field at magnetic medium 14 during the write process.

In order to maximize the write assist field generated by conductor 16 while minimizing the heat generated, the dimensions of conductor 16 are set to allow for maximum current I_{w} without exceeding the thermal limit set by the balance of Joule heat generation and optimal heat dissipation. This is achieved by setting width w_{w} of conductor 16 to approximately one to five times the trailing edge width wₜₚₜ at a head to medium spacing (HMS) much less than the trailing edge width wₜₚₜ. In various embodiments, width w_{w} is approximately equal to wₜₚₜ+(N×HMS) for N values in the range of about 10 to about 20.

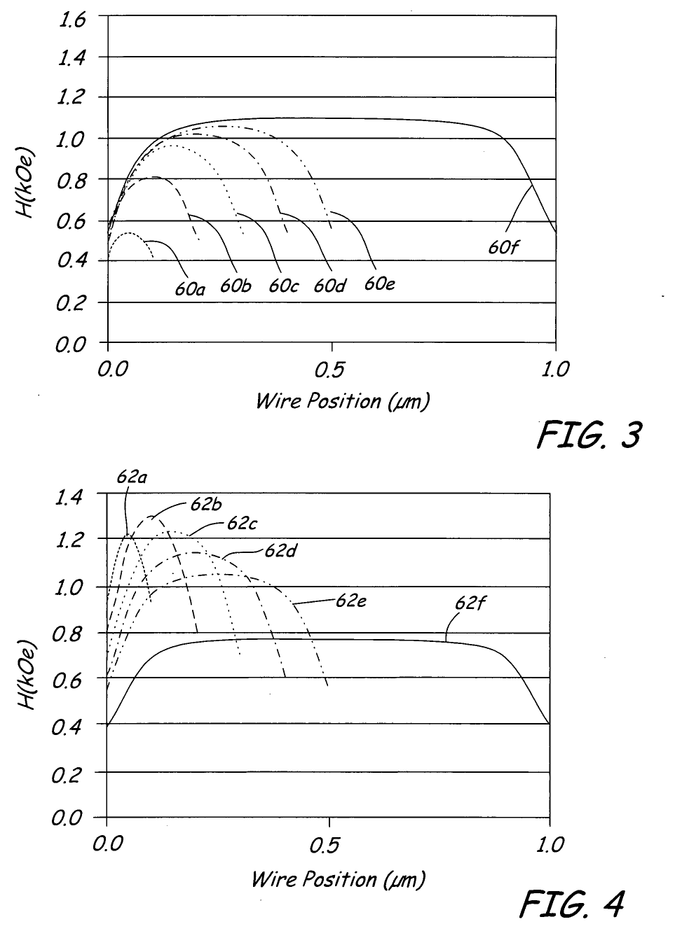

Write assist element 12 was simulated under various operating conditions to determine parameters for conductor 16 that maximize the write assist field generated by conductor 16 while minimizing the heat generated. The performance of write assist element 12 was simulated in a magnetic writer 10 including pole tip 34 having a width wₚₜ of approximately 0.1 μm, and a head-to-medium spacing (HMS) of approximately 10 nm. FIG. 3 is a graph showing the write assist field H generated by conductor 16 of various widths w_{w} versus cross-track position of conductor 16 at a fixed current I_{w}. In particular, line 60a shows write assist field H for a 0.1 μm conductor, line 60b shows write assist field H for a 0.2 μm conductor, line 60c shows write assist field H for a 0.3 μm conductor, line 60d shows write assist field H for a 0.4 μm conductor, line 60e shows write assist field H for a 0.5 μm conductor, and line 60f shows write assist field H for a 1.0 μm conductor. As is shown, the maximum field for each conductor 16 at the center of the conductor generally increases with an increasing widths w_{w}. However, the resistance of conductor 16 also increases proportional to the increased width, resulting in greater Joule heating when current I_{w} is passed through the conductor. Thus, the temperature rise associated with the increased width of conductor 16 should be considered in conjunction with the generation of a strong write assist field H with a good field gradient.

One approach to determining a good conductor width w_{w} while taking both write assist field strength and temperature rise into consideration is to test various conductor widths at a constant power. That is, the current I_{w} is decreased for longer conductors (which have a high resistance) to satisfy the equation P_{w}=I_{w}²R_{w}. FIG. 4 is a graph showing the write assist field H generated by conductor 16 of various widths at a fixed power. In particular, line 60a shows write assist field H for a 0.1 μm conductor, line 60b shows write assist field H for a 0.2 μm conductor, line 60c shows write assist field H for a 0.3 μm conductor, line 60d shows write assist field H for a 0.4 μm conductor, line 60e shows write assist field H for a 0.5 μm conductor, and line 60f shows write assist field H for a 1.0 μm conductor. The conductor having a length of 0.2 μm (line 60b) provides the highest maximum write assist field H, and thus based on this analysis the best width w_{w} for conductor 16 is 0.3 μm. However, this analysis does not take into consideration the operating temperatures of each conductor when operated at a constant power P_{w}.

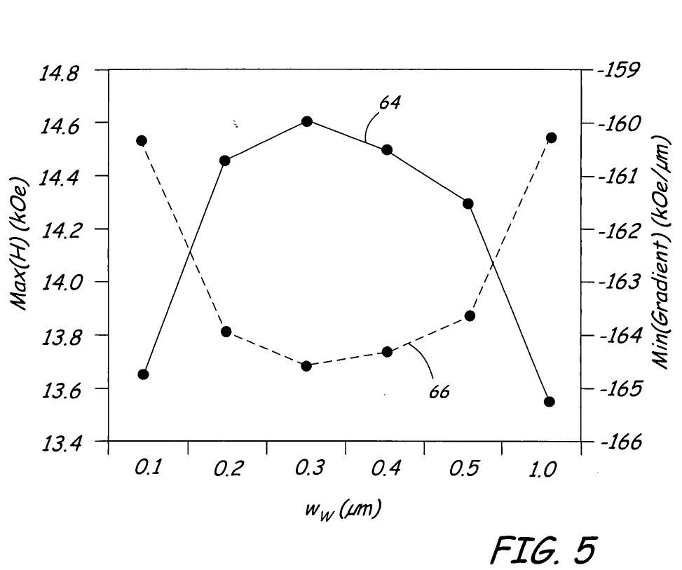

FIG. 5 is a graph showing the maximum write assist field and the minimum gradient generated by conductors of different lengths at a fixed temperature based on finite element modeling (FEM) of the write assist field at the center of conductor 16. Conductors having widths w_{w} of 0.1 μm, 0.2 μm, 0.3 μm, 0.4 μm, 0.5 μm, and 1.0 μm were tested with a current I_{w} to provide a constant operating temperature of 118.1° C. In order to provide this operating temperature, each of the conductors was tested with a current I_{w} and a current density as shown in the table below.

| Wire Length (μm) | Current I_{W} (mA) | Current Density (A/cm²) |
|---|---|---|
| 0.1 | 112.5 | 5.00 × 10⁸ |
| 0.2 | 91.5 | 4.07 × 10⁸ |
| 0.3 | 78.2 | 3.48 × 10⁸ |
| 0.4 | 68.1 | 3.03 × 10⁸ |
| 0.5 | 60.0 | 2.67 × 10⁸ |
| 1.0 | 40.5 | 2.00 × 10⁸ |

The maximum write assist field H measured for each conductor is shown in FIG. 5 as line 64, and the minimum field gradient (i.e., the sharpest field profile) is shown as line 66. Based on this analysis, the conductor that exhibited the highest maximum field H and the best field gradient at a constant temperature had a width w_{w} of 0.3 μm.

In summary, the present invention relates to a magnetic device including a first pole having a first pole tip. A conductor, which is adjacent an edge of the first pole tip, carries current to generate a second field that augments a first field generated by the first pole. The width of the conductor is in the range of about one to about five times the width of the trailing edge of the first pole tip. A magnetic device having these properties allows for very high conductor currents to provide a high write assist field and a good gradient while controlling temperature rise for good device reliability. In addition, the device is simple to fabricate with materials that have good electrical and thermal properties.

Although the present invention has been described with reference to preferred embodiments, workers skilled in the art will recognize that changes may be made in form and detail without departing from the spirit and scope of the invention.

1. A magnetic device comprising:
a first pole including a first pole tip;
a conductor adjacent to a trailing edge of the first pole tip for carrying current to generate a second field that augments a first field generated by the first pole, wherein a width of the conductor is in the range of about one to about five times a width of the trailing edge of the first pole tip.

2. The magnetic device of claim 1, wherein the conductor width is less than the sum of the trailing edge width and about 20 times a distance between the first pole tip and a magnetic medium.

3. The magnetic device of claim 1, and further comprising:
first and second current contacts for providing the current to the conductor.

4. The magnetic device of claim 3, wherein contact surfaces of the current contacts abut end surfaces of the conductor, and wherein the contact surfaces are larger than the end surfaces.

5. The magnetic device of claim 1, wherein the first pole and the conductor are separated by an insulating layer.

6. The magnetic device of claim 1, wherein a width of the conductor is at least equal to a corresponding width of the first pole tip.

7. The magnetic device of claim 1, wherein a width of the conductor is less than about 1.0 μm.

8. The magnetic device of claim 1, and further comprising:
a heat dissipating structure adjacent at least a portion of the conductor such that heat generated when current is carried by the conductor is dissipated at all external interfaces of the conductor.

9. The magnetic device of claim 8, wherein the heat dissipating structure comprises a material selected from the group consisting of Mo, W, Al, Cu, Au, Rh, Cr, Ir, Nb, Pd, Pt, Ru, Ag, other transition metals, and alloys thereof.

10. The magnetic device of claim 1, and further comprising:
a second pole magnetically coupled to the first pole.

11. A magnetic writer comprising:
a write element that produces a first field through a front surface;
a conductor adjacent the write element at the front surface;
current contacts for providing a current through the conductor to generate a second field that augments the first field at the front surface; and
a heat dissipating material adjacent to at least a portion of the conductor such that heat generated when the current is carried by the conductor is dissipated at all external interfaces of the conductor.

12. The magnetic writer of claim 11, wherein contact surfaces of the current contacts abut end surfaces of the conductor, and wherein the contact surfaces are larger than the end surfaces.

13. The magnetic writer of claim 11, wherein the write element and the conductor are separated by an insulating layer.

14. The magnetic writer of claim 11, wherein the conductor and the heat dissipating structure are separated by an insulating layer.

15. The magnetic writer of claim 11, wherein the conductor is adjacent a trailing edge of the write element.

16. A magnetic writer comprising:
a write pole including a write pole tip that produces a first magnetic field through a front surface of the write pole tip;
a conductor having a width at the front surface greater than a corresponding width of the write pole tip, wherein the conductor is disposed adjacent the write pole for carrying current parallel to the front surface to generate a second magnetic field that augments the first magnetic field; and
a heat dissipating structure adjacent at least a portion of the conductor distal from the front surface to dissipate heat generated by the conductor.

17. The magnetic writer of claim 16, wherein the heat dissipating structure comprises a material selected from the group consisting of Mo, W, Al, Cu, Au, Rh, Cr, Ir, Nb, Pd, Pt, Ru, Ag, other transition metals, and alloys thereof.

18. The magnetic writer of claim 16, and further comprising:
first and second current contacts for providing the current to the conductor.

19. The magnetic writer of claim 18, wherein contact surfaces of the current contacts abut end surfaces of the conductor, and wherein the contact surfaces are larger than the end surfaces.

20. The magnetic writer of claim 18, wherein the heat dissipating structure is adjacent to the first and second contacts.

21. The magnetic writer of claim 15, wherein the conductor is adjacent a trailing edge of the first pole tip.
